(19) United States
(12) Patent Application Publication
(10) Pub. No.: US 2012/0159887 A1
(43) Pub. Date: Jun. 28, 2012

(54) RAISED PROFILE PANEL FOR DOOR

(75) Inventor: Peter Yong SIBBETT, Tacoma, WA (US)

(73) Assignee: CAPSTONE ENGINEERING CO., LTD., Changnyeong-Gun (KR)

(21) Appl. No.: 13/087,821

(22) Filed: Apr. 15, 2011

(30) Foreign Application Priority Data
Nov. 29, 2010 (KR) 10-2010-0119667

(51) Int. Cl. E06B 3/72

(52) U.S. Cl. 52/455

(57) ABSTRACT

Disclosed is a raised profile panel having various patterns for a door, which allows a user to repair a profile of the door or change a design of the door according to the demand of the user without exchanging the door with a new one when the profile formed on a surface of the door for decoration is damaged or the user wants to change the design of the door. The raised profile panel includes a profile section manufactured separately from the door and having a bonding surface forming an inner wall of the profile section and an exposed surface forming an outer wall of the profile section; and an adhesive layer provided on the bonding surface of the profile section to bond the bonding surface of the profile section with the surface of the door.

### CROSS REFERENCE TO RELATED APPLICATIONS

This application claims the benefit and priority of Korean Patent Application No. 2010-0119667 filed Nov. 29, 2011. The entire disclosure of the above application is incorporated herein by reference.

### BACKGROUND OF THE INVENTION

1. Field of the Invention

The present invention relates to a door. More particularly, the present invention relates to a raised profile panel for a door, which allows a user to repair a profile of the door or change a design of the door according to the demand of the user without exchanging the door with a new one when the profile formed on a surface of the door for decoration is damaged or the user wants to change the design of the door.

2. Description of the Related Art

In general, a door used at home as an entrance/exit door includes an outer skin made from SMC (sheet molding compound) and urethane foam filled in the door.

In particular, the door is formed on an outer surface thereof with profiles including various patterns or concavo-convex configurations to provide the door with the aesthetic appearance. The profiles are prepared together with other parts of the door when the door is manufactured through a molding process.

However, if the profiles prepared as patterns or concavo-convex configurations are dug or broken, the door must be exchanged with a new one because it is impossible to repair only the damaged profiles. In this case, the user may feel dissatisfaction due to the additional expenses required for exchanging the door.

In addition, as the door has been used for a long time, the user may feel to change the design of the door even though durability of the door is still stable. In this case, the user must exchange the door with a new one having the design required by the user.

### SUMMARY

The present invention has been made to solve the problems occurring in the prior art, and an object of the present invention is to provide a raised profile panel having various patterns for a door, which allows a user to repair a profile of the door or change a design of the door according to the demand of the user without exchanging the door with a new one when the profile formed on a surface of the door for decoration is damaged or the user wants to change the design of the door.

In order to accomplish the above object, the present invention provides a raised profile panel for a door. The raised profile panel includes a profile section manufactured separately from the door, having a thickness thinner than a thickness of an outer skin of the door, and including a bonding surface forming an inner wall of the profile section and at least a part of which has a shape corresponding to a shape of a mounting surface formed on the door and an exposed surface forming an outer wall of the profile section and having patterns or concavo-convex configurations according to a demand of a user; and an adhesive layer provided on the bonding surface of the profile section to bond the bonding surface of the profile section with the surface of the door.

According to the present invention, the adhesive layer has a thickness in a range of 0.1 mm to 0.5 mm such that the adhesive layer serves as a damper when the profile section is compressed.

According to the present invention, the adhesive layer is provided on an entire surface of the bonding surface except for at least a region located at a lowest end of the bonding surface when the bonding surface attached to the door.

According to the present invention, the region where the adhesive layer is not provided has a width in a range of 10 mm to 50 mm.

According to the present invention, a coating groove having a step structure is formed at a part of an outer peripheral portion of the bonding surface forming the profile section, in which the part makes contact with the surface of the door, and silicon is filled in the coating groove.

According to the present invention, the silicon is filled in the coating groove except for at least a region located at a lowest end of the coating groove when the profile section is attached to the door.

As described above, the raised profile panel according to the present invention can be used for various purposes, such as repairing the damage to the surface of the door, and changing the local design of the door.

In particular, the raised profile panel according to the present invention includes the bonding surface serving as the inner surface of the raised profile panel and having a shape corresponding to a surface of the door, so the raised profile panel can be stably attached to the door and can reinforce the strength of the installation region.

Further, since the bonding surface serving as the inner surface of the profile section has a shape corresponding to a surface of the door, the raised profile panel can be stably attached to the door and can reinforce the strength of the installation region without requiring an additional assembly jig used for matching the position of the profile section with the surface of the door when the profile section is attached to the surface of the door.

In addition, according to the raised profile panel of the present invention, the adhesive layer of the profile section may not be coated onto the entire surface of the bonding surface of the profile section, but there is a region where the adhesive layer is not coated. The non-coat region is located at the lower portion of the bonding surface when the bonding surface is attached to the door. Thus, an air layer may not be formed when the profile section is installed and the raised profile panel may not be influenced by external factors, such as snow or rain. In particular, the silicon is coated on the outer peripheral portion of the profile section, so external moisture or humidity may not penetrate into the raised profile panel for the door.

### BRIEF DESCRIPTION OF THE DRAWINGS

FIG. 1 is a front view showing the installation state of a raised profile panel for a door according to an exemplary embodiment of the present invention;

FIG. 2 is an enlarged sectional view showing an internal structure of an “A” part shown in FIG. 1;

FIG. 3 is an enlarged sectional view showing an internal structure of a “B” part shown in FIG. 2; and

FIG. 4 is an enlarged sectional view showing an internal structure of a “C” part shown in FIG. 2.

### DETAILED DESCRIPTION OF THE EMBODIMENTS

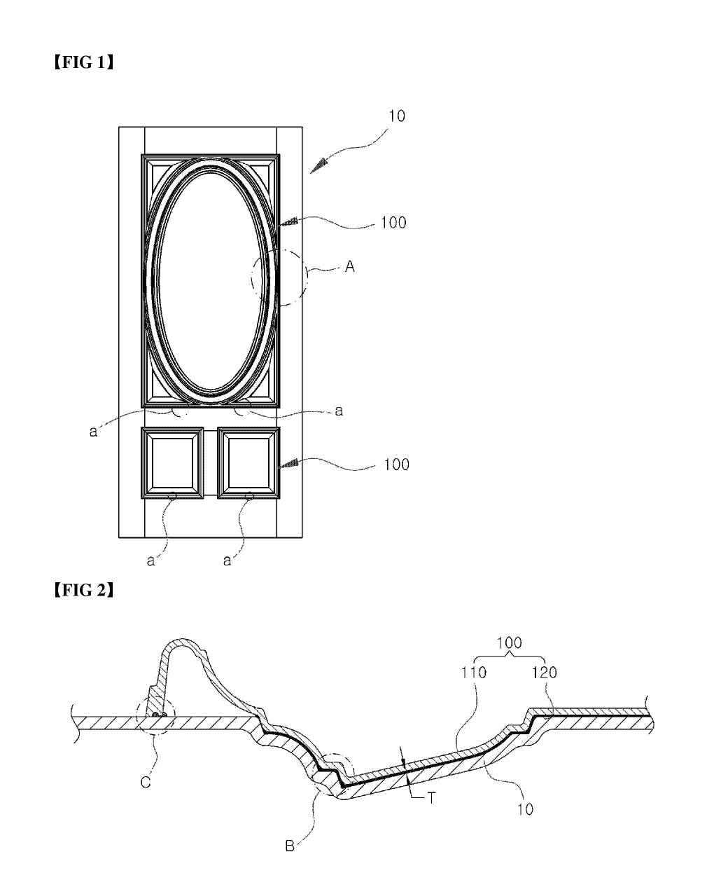

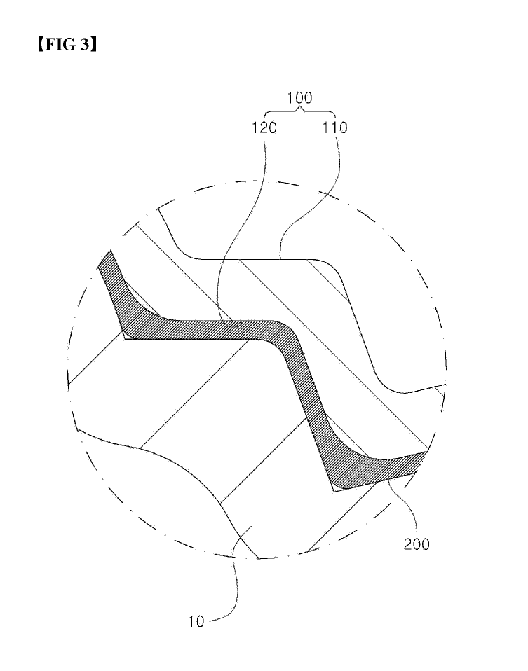

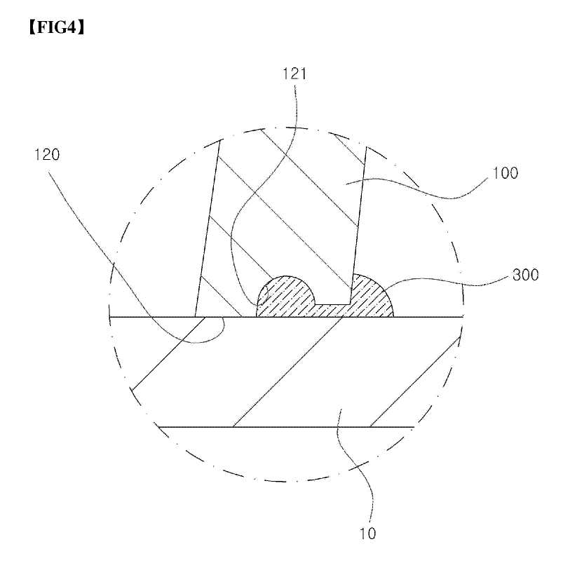

Hereinafter, a raised profile panel for a door according to exemplary embodiments of the present invention will be described with reference to FIGS. 1 to 4.

As shown in FIG. 1, the raised profile panel for the door according to the exemplary embodiment of the present invention mainly includes a profile section 100 and an adhesive layer 200.

In other words, the raised profile panel for the door according to the exemplary embodiment of the present invention has a profile corresponding to a pattern or a concavo-convex configuration formed on a surface (indoor surface or outdoor surface) of the door (10) while allowing a user to repair the profile or to change the design of the door 10.

Hereinafter, the structure of the raised profile panel for the door according to the exemplary embodiment of the present invention will be described in detail.

The profile section 100 is a body of the raised profile panel and is manufactured separately from the door 10.

In particular, the profile section 100 has a thickness thinner than a thickness of an outer skin of the door 10 such that the profile section 100 may have elasticity. Thus, when the profile section 100 is attached to the surface of the door 10, the profile section 100 may not excessively protrude from the surface of the door 10 while accurately adhering to the surface of the door 10.

The profile section 100 includes a bonding surface 120 forming an inner wall of the profile section 100 and an exposed surface 110 forming an outer wall of the profile section 100.

At least apart of the bonding surface 120 has a shape corresponding to a shape of a mounting surface formed on the door 10 and the exposed surface 110 has a pattern or a concavo-convex configuration according to the demand of the user.

Thus, the bonding surface 120 of the profile section 100 may include parts having shapes, which may not correspond to the shape of the mounting surface formed on the door 10. For instance, the parts correspond to edges and regions of the mounting surface which may not exert influence upon the strength.

Otherwise, the bonding surface 120 of the profile section 100 may completely match with the entire surface of the mounting surface including edges of the mounting surface. However, in this case, molding work is very difficult, so the error may occur in shape matching.

Therefore, it is preferred if the region causing the error in shape matching is used to compensate for the shape mismatching when other parts of the bonding surface 120 of the profile section 100 are attached to the surface of the door 10. In this regard, according to the present invention, a part of the bonding surface 120 of the profile section 100 has the shape corresponding to the shape of the mounting surface formed on the door 10. It is more preferred if the bonding position of the bonding surface 120 can be compensated by taking the adhesive layer 200, which will be described later, into consideration.

The adhesive layer 200 is provided to bond the profile section 100 to the surface of the door 10.

The adhesive layer 200 includes an adhesive to bond the profile section 100 to the surface of the door 10. In particular, the adhesive layer 200 has a thickness T in the range of 0.1 mm to 0.5 mm as shown in FIG. 2.

In this case, the adhesive layer 200 serves as a damper when the profile section 100 is compressed, so that durability and weatherability of the profile section 100 can be improved and the profile section 100 can accurately adhere to the surface of the door 10.

If the thickness T of the adhesive layer 200 is less than 0.1 mm, the damping property is lowered so that the durability may be deteriorated. In addition, if the thickness T of the adhesive layer 200 exceeds 0.5 mm, the profile section 100 may be excessively spaced apart from the surface of the door 10. Thus, the above thickness range is preferred for the adhesive layer 200.

Although the adhesive layer 200 can be formed on the entire surface of the bonding surface 120 of the profile section 100, according to the present invention, the adhesive layer 200 is provided on the entire surface of the bonding surface 120 except for at least a region located at a lowest end of the bonding surface 120 when the bonding surface 120 is attached to the door 10.

Due to the above structure, air formed in the profile section 100 and the adhesive layer 200 when the profile section 100 is bonded to the surface of the door 10 can be smoothly drained to the outside through a non-coat region (see, “a” of FIG. 1) where the adhesive layer 200 is not coated, so that the profile section 100 can accurately adhere to the surface of the door 10.

Since the door 10, which is an entrance/exit door used at home, is frequently exposed to the external environment, the non-coat region is located at the lowest end of the bonding surface 120 to prevent moisture, such as snow or rain, from penetrating into the raised profile panel for the door 10.

If the non-coat region is excessively large, the profile section 100 may not securely adhere to the surface of the door 10. In contrast, if the non-coat region is excessively small, the air may not be smoothly drained.

In this regard, the non-coat region preferably has a width in the range of 10 mm to 50 mm.

Therefore, when the surface of the door 10 is locally damaged, the raised profile panel for the door 10 having the above structure may overlap on the damaged surface while being secured by the adhesive layer 200, so that the damaged surface can be easily and simply repaired.

In particular, since the exposed surface of the profile section 100 can be formed with various patterns and configurations, the user can locally change the design of the surface of the door 10.

Meanwhile, according to the raised profile panel for the door having the above structure, if the adhesive layer 200 is coated on the wall part of the outer peripheral portion of the profile section 100 as well as the bonding surface 120 of the profile section, a gap between the profile section 100 and the surface of the door 10 may be exposed to the outside even if the adhesive layer 200 has the thickness in the range of 0.1 mm to 0.5 mm. In this case, moisture or humidity may penetrate into the gap.

Thus, according to the present invention, a coating groove 121 having a step structure is formed at a part of an outer peripheral portion of the bonding surface 120 forming the profile section 100, in which the part makes contact with the surface of the door 10, and silicon 300 is filled in the coating groove 121.

That is, moisture or humidity may penetrate into the raised profile panel for the door due to the silicon 300 filled in the coating groove 121.

In this case, the silicon 300 is filled in the coating groove 121 except for at least a region located at a lowest end of the coating groove 121 when the profile section 100 is attached to the door 10.

In detail, as described above, when the profile section 100 is bonded to the surface of the door 10, the air contained in the profile section 100 and the adhesive layer 200 can be smoothly drained through the non-coat region, in which the adhesive layer 200 is not coated, a non-filling section, in which the silicon 300 is not filled, so that the profile section 100 can accurately adhere to the surface of the door 10.

Meanwhile, the outer peripheral portion of the profile section 100 may have various shapes, other than the flat shape. In detail, as shown in the embodiment, the outer peripheral portion of the profile section 100 may be bent from the surface of the door 10, in such a manner that the outer peripheral portion of the profile section 100 can make contact with the surface of the door 10 due to elasticity.

As described, the raised profile panel according to the present invention can be used for various purposes, such as repairing the damage to the surface of the door 10, and changing the local design of the door 10.

In addition, the raised profile panel according to the present invention includes the bonding surface 120 serving as an inner surface of the profile section 100 and having a shape corresponding to a surface of the door 10, so the raised profile panel can be stably attached to the door 10 and can reinforce the strength of the installation region.

Further, since the bonding surface 120 of the profile section 100 constituting the raised profile panel for the door according to the present invention has a shape corresponding to a surface of the door 10, the profile section 100 can be automatically aligned when the profile section 100 is attached to the surface of the door 10 without requiring an additional assembly jig.

What is claimed is:

1. A raised profile panel for a door, the raised profile panel comprising:
a profile section manufactured separately from the door, having a thickness thinner than a thickness of an outer skin of the door, and including a bonding surface forming an inner wall of the profile section and at least a part of which has a shape corresponding to a shape of a mounting surface formed on the door and an exposed surface forming an outer wall of the profile section and having patterns or concavo-convex configurations according to a demand of a user; and
an adhesive layer provided on the bonding surface of the profile section to bond the bonding surface of the profile section with the surface of the door.

2. The raised profile panel of claim 1, wherein the adhesive layer has a thickness in a range of 0.1 mm to 0.5 mm such that the adhesive layer serves as a damper when the profile section is compressed.

3. The raised profile panel of claim 1, wherein the adhesive layer is provided on an entire surface of the bonding surface except for at least a region located at a lowest end of the bonding surface when the bonding surface is attached to the door.

4. The raised profile panel of claim 3, wherein the region where the adhesive layer is not provided has a width in a range of 10 mm to 50 mm.

5. The raised profile panel of claim 1, wherein a coating groove having a step structure is formed at a part of an outer peripheral portion of the bonding surface forming the profile section, in which the part makes contact with the surface of the door, and silicon is filled in the coating groove.

6. The raised profile panel of claims, wherein the silicon is filled in the coating groove except for at least a region located at a lowest end of the coating groove when the profile section is attached to the door.
